(19) United States
(12) Patent Application Publication
(10) Pub. No.: US 2005/0157358 A1
(43) Pub. Date: Jul. 21, 2005

(54) Process for producing optical recording element

(75) Inventor: Yuki Hasegawa, Osaka (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 11/037,053

(22) Filed: Jan. 19, 2005

(30) Foreign Application Priority Data
Jan. 21, 2004 (JP) P.2004-013069

(51) Int. Cl. G03H 1/02

(52) U.S. Cl. 359/7

(57) ABSTRACT

The present invention provides a process for producing an optical recording element comprising two transparent substrates and a photorefractive material sandwiched therebetween, the process comprising: (A) melting a photorefractive material on a first transparent substrate, and subjecting the molten photorefractive material to degassing treatment; (B) holding the first transparent substrate horizontally, while allowing the photorefractive material to face a downward direction; (C) press-bonding a second transparent substrate to the photorefractive material; and (D) cooling the photorefractive material to a temperature not higher than its glass transition temperature.

### FIELD OF THE INVENTION

The present invention relates to a process for producing an optical recording element employing a photorefractive material. According to the invention, an optical recording element is obtained which has no bubbles inside, has a reduced loss of refractive-index-modulated regions resulting from recording, and is excellent in the storage stability of recorded information.

### BACKGROUND OF THE INVENTION

Elements which have been known as elements for recording data in a large amount include optical recording elements such as magneto-optic recording media and media of the optical phase change type. However, there is a growing demand for higher-density recording because of the necessity of recording high-resolution image data, etc. A rewritable optical recording element of the hologram type employing a photorefractive material has been proposed as an element capable of recording such a large amount of data.

This photorefractive material is a material in which electrons and holes (hereinafter referred to as carriers) generate upon light irradiation and these carriers move and thereby generate a spatial electric field. The refractive index of this material changes accordingly. Namely, modulation of the refractive index is attained. When this photorefractive material is irradiated with a coherent light, the light is absorbed only by bright areas resulting from the coherent-light irradiation and is not absorbed by dark areas. As a result, a diffraction grating in which the refractive index changes periodically is formed in the material. The refractive-index modulation which is induced in the photorefractive material is caused to have a period different from the period of bright-dark intensity modulation of the coherent light. Consequently, when the material is irradiated with two coherent beams, energy transfer occurs between the beams and, as a result, transmitted beams differing in intensity ratio from the incident beams are obtained. Photorefractive materials, which have such properties, are expected to be applied to hologram recording elements, optical multiplexer/demultiplexers, beam amplifiers, image correlation processing, associative storage elements, and the like.

Among such photorefractive materials there are inorganic photorefractive materials comprising lithium niobate or the like. However, difficulties are encountered in sample preparation and molding. In contrast, photorefractive materials comprising organic compounds have moldability and ease of functional modification and are hence expected to be used in various applications (see W. E. Moerner and S. M. Silence, Chemistry Review, Vol.94, pp.127-155, 1994).

In producing typical recording elements employing such an organic photorefractive material, raw materials including a photoconductive compound and a sensitizer are first dissolved in an organic solvent. This solution is formed into a sheet to form a recording layer, and the solvent is thereafter removed. Because of this procedure, the recording layer has minute voids remaining therein and this leads to a loss of refractive-index-modulated regions recorded. Namely, such recording elements have poor storage stability of recorded information. A technique for eliminating this drawback is described in, e.g., JP 2002-109792 A. This technique comprises sandwiching a photorefractive material between two silica glass substrates and pressing the resultant assemblage to form the photorefractive material into a sheet and thereby form an optical recording layer. This technique is intended to heighten the density of a photorefractive material by compression through pressing.

However, even with those related-art techniques employing pressing or the like, the photorefractive material still has bubbles remaining therein. In particular, use of silica glass substrates having a large area tends to result in bubble inclusion.

### SUMMARY OF THE INVENTION

An object of the invention is to produce at low cost an optical recording element which has a recording layer having no voids therein, has no loss of refractive-index-modulated regions, and is excellent in the storage stability of recorded information.

Other objects and effects of the invention will become apparent from the following description.

The invention provides a process for producing an optical recording element comprising two transparent substrates and a photorefractive material sandwiched therebetween, the process comprising:

(A) melting a photorefractive material on a first transparent substrate by, e.g., heating, and subjecting the molten photorefractive material to degassing treatment;

(B) holding the first transparent substrate horizontally, while allowing the photorefractive material to face a downward direction;

(C) press-bonding a second transparent substrate to the photorefractive material; and

(D) cooling the photorefractive material to a temperature not higher than its glass transition temperature (hereinafter referred to as T_{g}).

In the invention, it is preferred to carry out the cooling in step (D) at a rate of 3 to 20° C./sec.

In the process of the invention, the photorefractive material applied to a first transparent substrate is degassed by a known technique, e.g., depressurization. Thereafter, the first transparent substrate is horizontally held for a given time period in such a manner that the photorefractive material is allowed to face a downward direction. As a result of this step, the photorefractive material comes into a state in which the film of the photorefractive material contains no bubbles and has a smooth round surface projecting downward (i.e., a state like that a drop clings downward to the substrate). Because of this, bubble inclusion into the photorefractive material during the press bonding of a second transparent substrate is prevented.

### BRIEF DESCRIPTION OF THE DRAWINGS

FIG. 1 is diagrammatic view showing steps of the process of the invention.

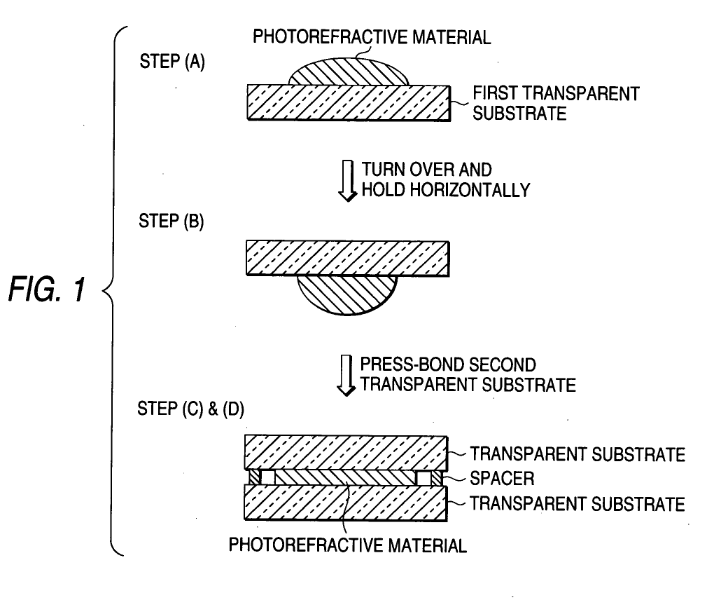

### DETAILED DESCRIPTION OF THE INVENTION

The invention will be explained below in detail.

(A) Step of Degassing on First Transparent Substrate:

The photorefractive material to be used in the invention may be any of the known materials for use in producing elements having such properties. Examples of inorganic photorefractive materials, among such materials, include LiNbO₃ and BaTiO₃.

Examples of organic photorefractive materials include, for example, those comprising a photoconductive compound, nonlinear optical dye, sensitizer, plasticizer, etc.

Examples of the photoconductive compound include poly(N-vinylcarbazole), N,N′-diphenyl-N,N′-bis(4-methylphenyl)-[1,1′-biphenyl]-4,4′-diamine, and tetraphenylbenzidine derivatives.

Examples of the nonlinear optical dye include 4-homopiperidinobenzylidenemalononitrile and 4-homopiperidino-2-fluorobenzylidenemalononitrile.

Examples of the sensitizer include 2,4,7-trinitro-9-fluorene and fullerene compounds such as C60 and C70.

Examples of the plasticizer include triphenylamine derivatives.

Other known ingredients including, e.g., organic polymeric compounds may be added to the above-mentioned organic photorefractive materials.

Those ingredients are uniformly mixed in an appropriate solvent (e.g., toluene, tetrahydrofuran, or dichloromethane).

The first transparent substrate may be any substrate which is transparent to the light with which the optical recording element is irradiated. Examples thereof include silica glass and soda glass. A conductive thin film such as an ITO film may be deposited as an electrode on that side of the substrate that is to be in contact with the photorefractive material, for the purpose of facilitating voltage application to the photorefractive material. Furthermore, for the purpose of preventing surface reflection, an antireflection layer may be formed on the side of the substrate opposite to the side to be in contact with the photorefractive material.

The first transparent substrate preferably has a thickness of 0.1 to 7 mm. The amount of the photorefractive material to be placed on the first transparent substrate is preferably about 0.001 to 2 g.

The liquid prepared by mixing the respective ingredients of the photorefractive material is dried to make it solid matter, and the solid matter is melted on the substrate by, e.g., heating at 120 to 180° C. The viscosity of the melt is preferably about 0.1 to 10 Pa.s in view of the subsequent step.

The degassing is conducted at a reduced pressure, generally a degree of vacuum of 0.13 to 4,000 Pa, for about from 5 seconds to 30 minutes until bubble generation discontinues.

(B) Step of Holding the First Transparent Substrate Horizontally, While Allowing the Photorefractive Material to Face a Downward Direction:

The holding of the first transparent substrate is not particularly limited as long as the substrate is held almost horizontally in such a degree that the photorefractive material does not flow off. The temperature at which the substrate is held is preferably 120 to 180° C. The time period of the holding is 1 to 60 seconds. By thus horizontally holding the first transparent substrate, the photorefractive material comes to have a smooth round surface projecting downward.

(C) Step of Press-Bonding Second Transparent Substrate to the Photorefractive Material:

The second transparent substrate to be used may be the same as or different from the first transparent substrate, depending on purposes.

A spacer is disposed between the first transparent substrate and the second transparent substrate to regulate the gap to a given value. As the spacer may be used any of spacers in general use for this purpose. It is desirable to use a material which is less apt to deform upon heating, such as, e.g., glass beads, a fluororesin, or a polyimide film. The thickness of the spacer is preferably from 12 μm to 2 mm, although it varies depending on the kind of the optical recording element.

In the press-bonding operation, it is preferred to regulate the temperature and viscosity of the photorefractive material to 120 to 170° C. and 0.1 to 10 Pa.s, respectively. The pressure for the press bonding is preferably about 0.2 to 3,500 g/cm².

The element obtained by sandwiching the photorefractive material between the first and second transparent substrates is molded to have a circular shape cross-section with a diameter of about from 5 mm to 12 cm.

(D) Step of Cooling the Photorefractive Material:

Subsequently, the element obtained by sandwiching the photorefractive material between the substrates is cooled to a temperature not higher than the T_{g} of the material. The T_{g} of the photorefractive material is generally about 0 to 100° C., and the element is suitably cooled to or below the T_{g} of the material. The rate of cooling is preferably 3 to 20° C./sec. By rapidly cooling the photorefractive material at such a rate, the material can be prevented from undergoing phase separation. For the cooling can be used an appropriate apparatus, e.g., an electronic cooler.

### EXAMPLES

The present invention will be illustrated in greater detail with reference to the following Examples, but the invention should not be construed as being limited thereto.

### Example 1

The following raw materials were dissolved in 26 g of toluene to obtain a solution of a photorefractive material.

| Ingredient | Amount |
|---|---|
| Tetraphenylbenzidine derivative (photoconductive compound) | 0.600 g |
| 4-Homopiperidinobenzylidenemalononitrile (nonlinear optical | 0.143 g |
| dye) | |
| 4-Homopiperidino-2-fluorobenzylidenemalononitrile (nonlinear | 0.143 g |
| optical dye) | |
| Fullerene C60 (sensitizer) | 0.005 g |
| Triphenylamine derivative (plasticizer) | 0.109 g |

Subsequently, the solvent was removed with an evaporator. The resultant residue was vacuum-dried at 65° C. for 24 hours to obtain a solid photorefractive material. This solid was melted on a hot plate heated at 150° C. and then kneaded so as to uniformly mix the ingredients. Thus, a photorefractive material was prepared.

(A) An ITO-coated soda glass (length: 7 cm, width: 7 cm, thickness: 1.1 mm) was prepared as a first transparent substrate. The photorefractive material obtained through kneading was placed in an amount of 0.2 g on the first transparent substrate heated at 150° C. The photorefractive material was thus melted and then degassed at a reduced pressure until bubble generation discontinues. This photorefractive material was examined with a viscosity/viscoelasticity measuring apparatus (Rheostress RS1, manufactured by TermoHaake) and, as a result, the viscosity (150° C.) of the material was found to be 1 Pa.s.

(B) Subsequently, the first transparent substrate was horizontally held with a clamp at 150° C. for 15 seconds, while allowing the photorefractive material to face a downward direction. This photorefractive material was examined with the viscosity/viscoelasticity measuring apparatus. As a result, the viscosity (150° C.) of the material was ascertained to be 1 Pa.s. Through this horizontal holding, the photorefractive material came to have a smooth round surface projecting downward and have a pseudo-hemispherical shape, its cross-section on the substrate having a circular shape with a diameter of 1.7 cm and a thickness of the pseudo-hemisphere as measured at the center of the circle being 0.6 cm.

(C) As a second transparent substrate was used an ITO-coated soda glass (length: 7 cm, width: 7 cm, thickness: 1.1 mm). A glass spacer having an average particle diameter of 100 μm was disposed in a peripheral part of the second transparent substrate. The first transparent substrate, with the photorefractive material kept facing downward, was placed over the second transparent substrate so that the photorefractive material came into contact with the second transparent substrate. This assemblage was pressed at a pressure of 18 g/cm² and a temperature of 150° C. for 1 minute. The photorefractive material was then formed to have a circular shape cross-section with a diameter of 4.6 cm.

(D) The photorefractive material sandwiched between the first and second transparent substrates was cooled to 10° C., which was lower than the T_{g} (35° C.) of the photorefractive material, at a rate of 7° C./sec on an electronic cooler having a surface temperature of −4.5° C. Thus, an optical recording element was obtained while avoiding bubble inclusion in the photorefractive material. The absence of bubbles was ascertained by examination with a microscope and by the fact that application of a voltage of 80 V/μm did not result in breakage.

### Comparative Example 1

An optical recording element was produced in the same manner as in Example 1, except that in step (B) in Example 1, the first transparent substrate was horizontally held, with the photorefractive material faced upward, and the second transparent substrate was placed thereon and pressed. This optical recording element contained minute bubbles and suffered breakage upon voltage application (40 V/μm). It was unusable as an optical recording element.

According to the present invention, an optical recording element which has a recording layer having no voids, has no loss of refractive-index-modulated regions, and is excellent in the storage stability of recorded information can be easily produced at low cost.

While the present invention has been described in detail and with reference to specific embodiments thereof, it will be apparent to one skilled in the art that various changes and modifications can be made therein without departing from the spirit and scope thereof.

The present invention is based on Japanese Patent Application No. 2004-013069 filed Jan. 21, 2004, the contents thereof being herein incorporated by reference.

1. A process for producing an optical recording element comprising two transparent substrates and a photorefractive material sandwiched therebetween, the process comprising:
(A) melting a photorefractive material on a first transparent substrate, and subjecting the molten photorefractive material to degassing treatment;
(B) holding the first transparent substrate horizontally, while allowing the photorefractive material to face a downward direction;
(C) press-bonding a second transparent substrate to the photorefractive material; and
(D) cooling the photorefractive material to a temperature not higher than its glass transition temperature.

2. The process for producing an optical recording element of claim 1, wherein the cooling of the photorefractive material in step (D) is carried out at a rate of 3 to 20° C./sec.

3. An optical recording element produced by the process of claim 1.
